(19) United States
(12) Patent Application Publication
(10) Pub. No.: US 2012/0137079 A1
(43) Pub. Date: May 31, 2012

(54) CACHE COHERENCY CONTROL METHOD, SYSTEM, AND PROGRAM

(75) Inventor: Makoto Ueda, Kyoto (JP)

(73) Assignee: International Business Machines Corporation, Armonk, NY (US)

(21) Appl. No.: 13/298,371

(22) Filed: Nov. 17, 2011

(30) Foreign Application Priority Data
Nov. 26, 2010 (JP) JP2010/070116
Nov. 26, 2010 (JP) JP2010263714

(51) Int. Cl. G06F 12/10; G06F 12/08

(52) U.S. Cl. 711/141; 711/E12.022; 711/E12.061

(57) ABSTRACT

In a system for controlling cache coherency of a multiprocessor system in which a plurality of processors share a system memory, each of the plurality of processors including a cache and a TLB, the processor includes a TLB controller including a TLB search unit that performs a TLB search and a coherency handler that performs TLB registration information processing when no hit occurs in the TLB search and a TLB interrupt occurs. The coherency handler includes a TLB replacement handler that searches a page table in the system memory and that replaces the TLB registration information, a TLB miss exception handling unit, and a storage exception handling unit.

### TECHNICAL FIELD

The present invention relates to cache coherency control, and in particular, to a method, system, and program for controlling cache coherency of a shared memory multiprocessor.

### BACKGROUND ART

A multiprocessor system carries out a plurality of tasks or processes (hereinafter referred to as “processes”) at the same time. Each of the plurality of processes typically has a virtual address space for use in carrying out the process. A location in such a virtual address space contains an address mapped in a physical address in a system memory. It is not uncommon for a single space in a system memory to be mapped in a plurality of virtual addresses in a multiprocessor. When each of a plurality of processes uses a virtual address, these addresses are translated into physical addresses in a system memory and, if no proper instruction or data exists in a cache in a processor for carrying out each of the processes, they are extracted from the system memory and stored in the cache.

To quickly translate virtual addresses in a multiprocessor system into physical addresses in a system memory and obtain a proper instruction or data, a so-called translation look-aside buffer (hereinafter referred to as “TLB”) related to a cache is used. A TLB is a buffer that contains a translation relation between a virtual address and a physical address generated using a translation algorithm. The use of the TLB enables very efficient address translation; however, if such a buffer is used in a symmetric multiprocessing (hereinafter referred to as “SMP”) system, an incoherency problem arises. For a data processing system in which a plurality of processors can read and write information from and to a shared system memory, care must be taken to ensure that the memory system operates in a coherent manner. That is, incoherency of the memory system as a result of processes carried out by the plurality of processors is not permitted. Each of the processors in such a multiprocessor system typically contains a TLB for use in address translation related to a cache. To maintain coherency, a shared memory mode in such a system must map a change on a TLB of a single processor in the multiprocessor to TLBs of the other processors with caution and without inconsistency.

For a multiprocessor, coherency of TLBs can be maintained by, for example, the use of an inter-processor interrupt (IPI) and software synchronization in modifications to all TLBs. This technique can ensure memory coherency over the whole multiprocessor system. In a typical page memory system, the content of each TLB in a multiprocessor system reflects a section related to a cache of the content of a page table retained in the system memory. A page table is generally a memory map table that contains virtual addresses or segments thereof and physical addresses associated with them. Such a page table typically further contains other various types of management data, including a page protection bit, a valid entry bit, and various kinds of access control bit. For example, a bit that explicitly indicates the necessity of coherency (memory coherence required attribute) can be defined as management data to statically configure whether the page really needs coherency. However, this bit statically configuring method is efficiently used only in some special programs that are allowed to be rewritable to software-control a cache because, in addition to the necessity of statically configuring the above-described bit, such a bit must be statically configured in the whole system memory.

In recent years, a desktop personal computer (PC) that has a plurality of central processing units (CPUs) and SMP-Linux (Linux is a trademark of Linus Torvalds in the United States and other countries) have become popular, and many application programs have supported shared memory multiprocessors, that is, SMP systems. Therefore, an increase in the number of processors in a system improves a throughput of an application program without rewriting software. A general-purpose operating system (OS) that advances supporting SMP, for example, SMP-Linux has been scaled up to one that can control no less than 1024 processors. The feature that throughput can be improved by an increase in the number of processors without rewriting of software is an advantage that does not lie in a multiprocessor system that does not share a memory, such as a cluster that uses message passing programming. Accordingly, SMP is a multiprocessor system suited for protecting software assets.

However, scalability of a SMP system is lower than that of a cluster based on message passing. This is because the cost of hardware that supports cache coherency dramatically increases with an increase in the number of processors of an SMP system to improve scalability. Examples of hardware supports for cache coherency of an SMP system can include the modified, exclusive, shared, invalid (MESI) snoop protocol, which is used in a shared bus of a desktop PC and achieved by inexpensive hardware, and a directory-based protocol that is used in cache coherent, non-uniform memory access (hereinafter referred to as “CC-NUMA”) in a large-scale distributed shared memory (DSM) system and achieved by expensive hardware that integrates special inter-node connection with, for example, a protocol processor and directory memory. An increase in the number of processors using CC-NUMA leads to an increase in hardware cost, and thus, the cost performance of a multiprocessor decreases with an increase in the number of processors. That is, economic scalability of CC-NUMA is low. In contrast to this, because a cluster can be made of standard components, the hardware cost per processor for a cluster is less expensive than that for CC-NUMA, which needs dedicated components. In particular, a cluster that has constant hardware cost per processor can perform massively parallel processing if it rewrites an embarrassingly parallel application program having high parallelism using a message passing interface.

Non-Patent Literature 1 describes a virtual memory (VM)-based shared memory technique that utilizes hardware in a memory management unit (hereinafter referred to as “MMU”) included in a processor to improve scalability and cost performance of an SMP system. This technique was applied to non-cache coherent NUMA (hereinafter referred to as “NCC-NUMA”) described in Non-Patent Literature 2, which can use hardware as inexpensive as that of a cluster. The VM-based shared memory technique deals with cache coherency in the same process, but it cannot deal with cache coherency between different processes. In particular, because it is common for a general-purpose OS that supports a virtual address and manages memory using the copy-on-write technique to map the same physical page to a plurality of processes, data to which the VM-based shared memory technique is applicable is limited to data that ensures that an application program is not shared by different processes, and cache coherency transparent from an application program cannot be implemented. In other words, the necessity to explicitly indicate data of the same virtual address space shared by a plurality of processors arises, and in order to apply the technique to existing software, it is necessary to rewrite an application program, thus resulting in additional software cost related to it. Accordingly, the VM-based shared memory technique cannot be applied to a general-purpose computer, and the applicability of that technique is limited to a specific use and scientific computation that allows the program to be newly designed.

Patent Literature 1 describes a main memory shared type multiprocessor in which the addition of a small amount of hardware by the provision of a physical page map table can eliminate or significantly reduce the need to broadcast a TLB purge transaction to control TLB consistency in rewriting the page table and can eliminate or significantly reduce a traffic in a bus in a network and nodes and a pipeline stall of a processor associated with TLB purging.

Patent Literature 2 describes enabling an operation of accessing a content-addressable memory, such as a cache memory (CACHE-M) or an address translation buffer (TLB), in response to a data transfer instruction, such as a MOV instruction, and invalidating an entry, for example.

Patent Literature 3 describes the introduction of a pair of software instructions to enable direct insertion of translation information, such as address translation pair, by software, a page fault handler capable of both inserting the translation information into the page directory and inserting that information into TLB, and ensuring that, after the completion of an execution of a page fault handler routine, when the same virtual address is provided in the next time, not a TLB miss but a TLB hit occurs.

### SUMMARY OF INVENTION

Accordingly, it is an object of the present invention to achieve cache coherency control that enables an increase in scalability of a shared memory multiprocessor system and an improvement in the cost performance while the cost of hardware and software is kept low. The object of the present invention includes providing a method, system, and program product for achieving such cache coherency control. The object of the present invention also includes achieving such cache coherency control by software using inexpensive hardware configuration. The object of the present invention further includes achieving such cache coherency control by software transparently from an application program, that is, without rewriting an application program.

A method for controlling cache coherency according to one embodiment of the present invention controls cache coherency of a multiprocessor system in which a plurality of processors share a system memory, each of the plurality of processors including a cache and a TLB. When a processor of the plurality of processors determines that a TLB interrupt that is not a page fault occurs in a TLB search, the method includes performing, by the processor, a TLB miss exception handling step of handling the TLB interrupt being a TLB miss interrupt occurring when no registration information having a matching address exists in the TLB or a storage exception handling step of handling the TLB interrupt being a storage interrupt occurring when registration information having a matching address exists in the TLB but access right is invalid. The TLB miss exception handling step may include the step of flushing a data cache line of a cache belonging to a physical page covered by a victim TLB entry evicted and discarded when TLB replacement is executed. The TLB miss exception handling step or the storage exception handling step may include the steps of determining whether memory access that caused the TLB miss interrupt or the storage interrupt is data access or instruction access and, when determining that the memory access is the data access, providing right to write, read, and execute to a physical page covered by a TLB entry replaced or updated in association with the access with exclusive constraint that it is exclusive of access right to the physical page in the TLB of another processor.

Preferably, the step of providing the right to write, read, and execute with the exclusive constraint may include a processing step of providing the right to write, read, and execute with invalidate-on-write constraint. The step of providing the right to write, read, and execute with the invalidate-on-write constraint may include an MESI emulation processing step of providing the right to write, read, and execute with constraint of the MESI protocol.

Preferably, the MESI emulation processing step may include the steps of determining whether the memory access is a data write or read, when determining that the memory access is the data read, setting on a read attribute to the physical page of the access in the TLB of the processor and the TLB directory memory retaining registration information for the TLBs of the plurality of processors, searching the TLB directory memory for the physical page of the access and determining whether the TLB of the other processor has right to write to the physical page of the access, when determining that the other processor has the right to write, notifies the other processor of a clean command by an inter-processor interrupt and causing the other processor to clear the right to write to the physical page of the access, and clearing a write attribute to the physical page of the access for the TLB of the other processor in the TLB directory memory. The step of causing the other processor to clear the right to write to the physical page of the access may include the step of causing the other processor to copy back the data cache and to disable the write attribute to the physical page of the access in the TLB of the other processor.

Preferably, the MESI emulation processing may include the steps of, when determining that the memory access is the data write, setting on the write attribute to the physical page of the access in the TLB of the processor and the TLB directory memory, searching the TLB directory memory for the physical page of the access and determining whether the TLB of the other processor has the right to read, write, or execute to the physical page of the access, when determining that the other processor has the right to write, read, or execute to the physical page, notifying the other processor of a flush command by an inter-processor interrupt and causing the other processor to clear the right to read, write and execute to the physical page of the access, and clearing the read, write, and execute attributes to the physical page of the access for the TLB of the other processor in the TLB directory memory. The step of causing the other processor to clear the right to read, write, and execute to the physical page of the access may include the step of causing the other processor to copy back and invalidate the data cache and to disable the read, write, and execute attributes to the physical page of the access in the TLB of the other processor.

Preferably, the TLB miss exception handling step or the storage exception handling step may include the steps of determining whether memory access that caused the TLB miss interrupt or the storage interrupt is data access or instruction access, when determining that the memory access is the instruction access, determining whether an entry in a page table in the system memory has right of user write permission to the physical page at which the TLB miss interrupt results from an instruction fetch, when determining that the entry in the page table has the right of user write permission, determining whether the TLB of the other processor has right of user write permission to the physical page, and, when determining that the TLB of the other processor has the right of user write permission, notifying the other processor of a clean command by an inter-processor interrupt and causing the other processor to clear the right of user write permission. When it is determined that the TLB of the other processor does not have the right of user write permission or after the step of causing the other processor to clear the right of user write permission, the TLB miss exception handling step or the storage exception handling step may include the step of invalidating an instruction cache of the processor that made the access. When it is determined that the entry in the page table does not have the right of user write permission or after the step of invalidating the instruction cache of the processor that made the access, the TLB miss exception handling step or the storage exception handling step may include the step of setting on the execute attribute to the physical page at which the TLB miss interrupt results from the instruction fetch in the TLB of the processor that made the access and the TLB directory memory retaining registration information for the TLBs of the plurality of processors.

Preferably, the MESI emulation processing step may further include the step of making sequential access using a semaphore in searching the TLB directory memory for the physical page of the access.

With one embodiment of the present invention, a computer program product for cache coherency control, the computer program product causing a processor to execute each of the steps described above, is provided.

A system for controlling cache coherency according to another embodiment of the present invention controls cache coherency of a multiprocessor system in which a plurality of processors each including a cache and a TLB share a system memory. Each of the processor further includes a TLB controller including a TLB search unit that performs a TLB search and a coherency handler that performs TLB registration information processing when no hit occurs in the TLB search and a TLB interrupt occurs. The coherency handler includes a TLB replacement handler, a TLB miss exception handling unit, and a storage exception handling unit. The TLB replacement handler searches a page table in the system memory and performs replacement on TLB registration information. When the TLB interrupt is not a page fault, the TLB miss exception handling unit handles the TLB interrupt being a TLB miss interrupt occurring when no registration information having a matching address exists in the TLB and the storage exception handling unit handles the TLB interrupt being a storage interrupt occurring when registration information having a matching address exists in the TLB but access right is invalid. The TLB miss exception handling unit may flush a data cache line of a cache belonging to a physical page covered by a victim TLB entry evicted and discarded when TLB replacement is executed. Each of the TLB miss exception handling unit and the storage exception handling unit may determine whether memory access that caused the TLB miss interrupt or the storage interrupt is data access or instruction access, and, when determining that the memory access is the data access, may provide right to write, read, and execute to a physical page covered by a TLB entry replaced or updated in association with the access with exclusive constraint that it is exclusive of access right to the physical page in the TLB of another processor.

Each of the TLB miss exception handling unit and the storage exception handling unit may determine whether memory access that caused the TLB miss interrupt or the storage interrupt is data access or instruction access, when determining that the memory access is the instruction access, may determine whether an entry in a page table in the system memory has right of user write permission to the physical page at which the TLB miss interrupt results from an instruction fetch, when determining that the entry in the page table has the right of user write permission, may determine whether the TLB of the other processor has right of user write permission to the physical page, and, when determining that the TLB of the other processor has the right of user write permission, may notify the other processor of a clean command by an inter-processor interrupt and causes the other processor to clear the right of user write permission.

The system for controlling cache coherency may further include a TLB directory memory that retains registration information for the TLBs of the plurality of processors and that is searched for a physical page by the plurality of processors.

Preferably, the multiprocessor system may include a plurality of nodes, each of the plurality of nodes may include the plurality of processors, the system memory connected to the plurality of processors by a coherent shared bus, and the TLB directory memory, and a semaphore handler that is used in sequential access to the TLB directory memory by the plurality of processors using a semaphore, the TLB directory memory and the semaphore handler being connected to the coherent shared bus by a bridge mechanism. The plurality of nodes may be connected to each other by an NCC-NUMA mechanism.

Embodiments of the present inventions show cache coherency control that enables an increase in scalability of a shared memory multiprocessor system and an improvement in the cost performance while the cost of hardware and software is kept low can be achieved. In particular, a method, system, and program product for achieving such cache coherency control are provided, the cache coherency control can be achieved by software using inexpensive hardware configuration, and additionally, it can be achieved without rewriting an application program.

### BRIEF DESCRIPTION OF DRAWINGS

FIG. 1 is a block diagram that schematically illustrates a multiprocessor system that can be used in achieving cache coherency control.

FIG. 2 is a block diagram that schematically illustrates a cache coherency control system according to one embodiment of the present invention.

FIG. 3 illustrates a schematic configuration of a TLB directory memory.

FIG. 4 is a flowchart that schematically illustrates a method for controlling cache coherency according to one embodiment of the present invention.

FIG. 5 is a flowchart that illustrates eviction processing on a victim TLB entry in a subroutine of each of TLB miss exception handling and storage exception handling by a coherency handler.

FIG. 6 is a flowchart that illustrates MESI emulation processing in a subroutine of each of TLB miss exception handling and storage exception handling by a coherency handler.

FIG. 7 is a flowchart that illustrates instruction cache coherency processing in a subroutine of each of TLB miss exception handling and storage exception handling of a coherency handler.

FIG. 8 depicts flows illustrating how a semaphore is used for an entrance and an exit of a coherency handler.

FIG. 9 illustrates a schematic configuration of a coherent shared memory multiprocessor system extended to a hybrid system of SMP and NCC-NUMA.

FIG. 10 illustrates a schematic configuration of a local TLB directory memory for LSM.

### DESCRIPTION OF EMBODIMENTS

The embodiments below are not intended to limit the scope of claims of the invention, and not all of the combinations of the features described in the embodiments are required for solution to problem. The present invention may be embodied in many different forms and should not be construed as limited to the contents of the embodiments set forth herein. The same portions and elements have the same reference numerals throughout the description of the embodiments.

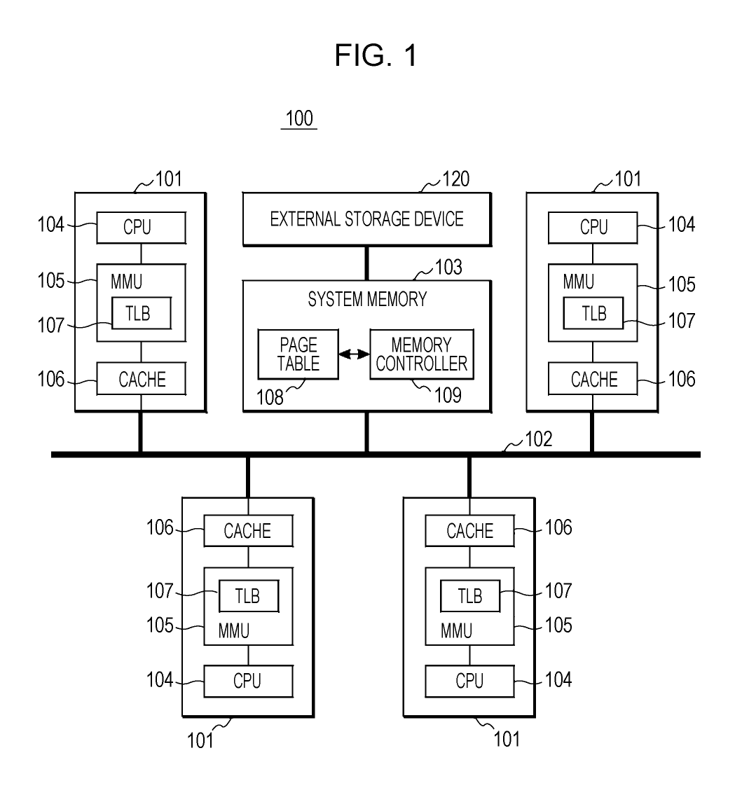

FIG. 1 is a block diagram that schematically illustrates a multiprocessor system 100 that can be used in achieving cache coherency control according to the present invention. The multiprocessor system 100 includes a plurality of processors 101, a memory bus 102, and a system memory 103. The processors 101 are connected to the system memory 103 by the memory bus 102. Each of the processors 101 includes a CPU 104, an MMU 105, and a cache 106. The MMU 105 includes a TLB 107. The cache 106 in the processor 101 holds part of the content of the system memory 103. For an SMP system, such as the multiprocessor system 100, the processors 101 can read and write information from and to the system memory 103, and it is necessary to make data and instructions in the system memory 103 and in the caches 106 coherent. Preferably, the system memory 103 may be provided with a page table 108 therein. The use of a plurality of entries, that is, pieces of registration information in the page table 108 enables virtual addresses to be efficiently mapped to physical addresses in the system memory 103. The system memory 103 includes a memory controller 109 and exchanges information related to storage information with an external storage device 120 connected thereto, that is, reads and writes information from and to the external storage device 120. Each of the processors 101 can translate a virtual address in an instruction or data to a physical address in the system memory 103 by duplicating information contained in each entry in the page table 108 using the TLB 107. Because the TLB 107 provides address information in a memory space, in order to ensure a correct operation of the TLB 107, it is important to maintain coherence among the TLBs 107 in the multiprocessor system 100.

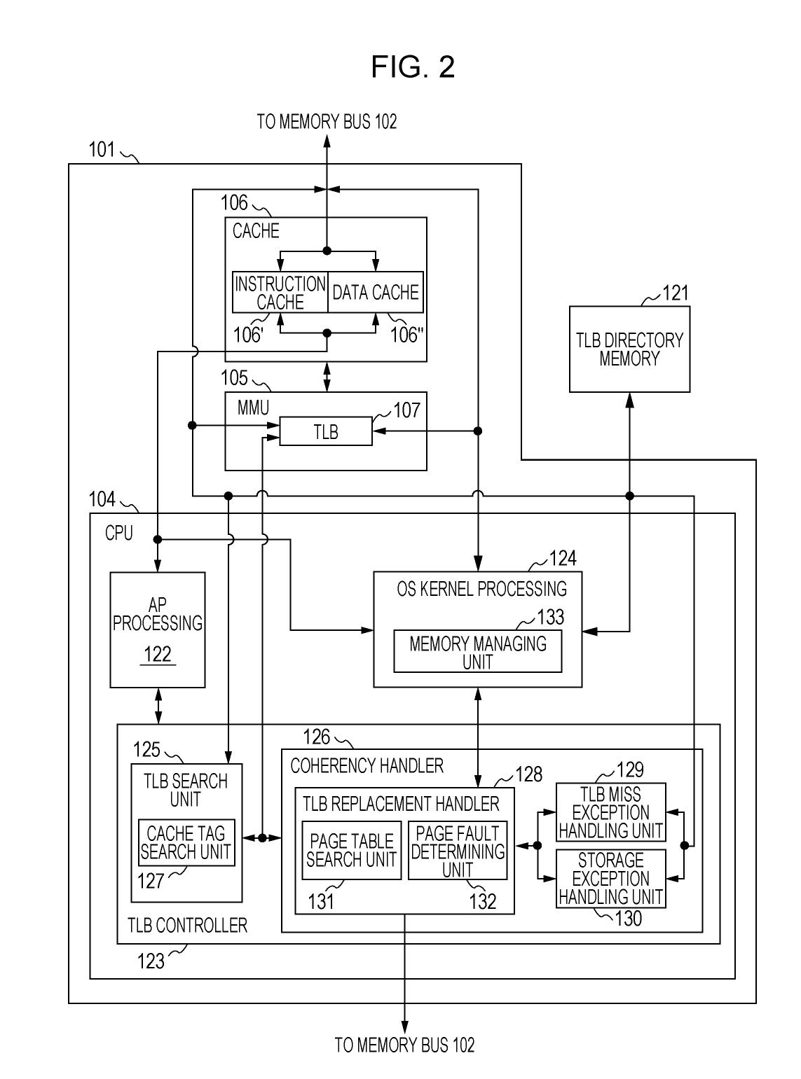

FIG. 2 is a block diagram that schematically illustrates the processor 101 having a cache coherency control system according to one embodiment of the present invention. The cache 106 of the processor 101 includes an instruction cache 106′ and a data cache 106″. The processor 101 is connected to a TLB directory memory 121 which all the processors 101 can access, in addition to the memory bus 102. The TLB directory memory 121 is one in which information, such as a physical page number, a read/write/execute access right, and a valid status, held in the TLBs 107 of all the processors 101 is duplicated and the duplicated information is mapped to global addresses to which the CPUs 104 of all the processors 101 can refer in order that a local processor 101 can examine the content of the TLB 107 of a remote processor 101 without interrupting the remote processor 101 using an inter-processor interrupt. Each of the CPUs 104 has an operational mode at which application program (AP) processing 122 is executed (user mode), an operational mode at which OS kernel processing 124 is executed (supervisor mode), and an operational mode at which an interrupt handler is executed. A coherency handler 126 is executed in third operational mode. A TLB controller 123 includes a TLB search unit 125 for performing a TLB search at the time the AP processing 122 accesses the cache 106 or at the time the OS kernel processing 124 accesses the cache 106 and the coherency handler 126 for executing registration information processing of the TLB 107 when no hit occurs in a TLB search and a TLB interrupt occurs. The coherency handler 126 is positioned outside the OS kernel processing 124 for handling a page fault, as illustrated in FIG. 2.

The TLB search unit 125 includes a cache tag search unit 127 for searching cache tags when a hit occurs in a TLB search. When a hit occurs in a cache tag search, the cache tag search unit 127 instructs the AP processing 122 to access the cache 106. When no hit occurs but a cache tag miss occurs in a cache tag search, the cache tag search unit 127 instructs the AP processing 122 to access not the cache 106 but the system memory 103.

The coherency handler 126 includes a TLB replacement handler 128, a TLB miss exception handling unit 129, and a storage exception handling unit 130. The TLB replacement handler 128 includes a page table search unit 131 and a page fault determining unit 132. The page table search unit 131 performs a search on the page table 108 in the system memory 103 in the case of a TLB interrupt found by the TLB search unit 125. The page fault determining unit 132 determines from the search performed by the page table search unit 131 whether a page fault occurs. When the page fault determining unit 132 determines that no page fault occurs from the search performed by the page table search unit 131, that is, that a TLB entry page exists in the page table 108, the TLB miss exception handling unit 129 or the storage exception handling unit 130 executes coherency control. Of the cases where, although a TLB entry page exists in the page table 108 and no page fault occurs, no hit is found in a TLB search and a TLB interrupt occurs, a case where an entry that matches the address, that is, registration information does not exist in the TLB, is referred to as “TLB miss interrupt” and a case where an entry that matches the address, that is, registration information exists in the TLB, but access right is invalid is referred to as “storage interrupt.” The TLB miss exception handling unit 129 handles a TLB miss interrupt, whereas the storage exception handling unit 130 handles a storage interrupt. Because the coherency handler 126 executes coherency control when no page fault occurs, this technique differs from the VM-based shared memory technique, which executes coherency control when a page fault occurs.

The OS kernel processing 124 includes a memory managing unit 133. When the page fault determining unit 132 determines from a search performed by the page table search unit 131 that a page fault occurs, the TLB replacement handler 128 generates a page fault interrupt and the memory managing unit 133 of the OS kernel processing 124 handles the page fault.

The TLB miss exception handling unit 129 and the storage exception handling unit 130 of the coherency handler 126 execute coherency control such that only a physical address registered in the TLB 107 in a local processor 101 is held in the cache 106. Because of this, when the coherency handler 126 executes TLB replacement, a physical page covered by a TLB entry, that is, registration information to be evicted and discarded as a victim is flushed, that is, copied back and invalidated from the cache. In addition, the read/write/execute right to a physical page covered by an added TLB entry, that is, registration information is subjected to exclusive constraint that it is exclusive of the access right to that physical page in the TLB 107 of a remote processor 101. Examples of the exclusive constraint include invalidate-on-write, in particular, the constraint of the MESI protocol. The MESI protocol is a coherency protocol classified to a write invalidate type. There is also a write update type. Both types may be used. The constraint of the MESI protocol is described below. If such constraint is added, it is not necessary to deal with coherency unless a TLB miss occurs. Because the VM-based shared memory technique exclusively caches a logical page held in a page table, in the case where the same physical page is mapped to different logical pages, the technique cannot address coherency.

When a TLB entry, that is, registration information is replaced, that is, substituted or updated for a TLB miss interrupt and storage interrupt, the read/write/execute right that conforms to the constraint of the MESI protocol is provided. For a processor in which a page table search is assisted by hardware, the TLB is merely one in which part of the page table is cached, whereas for the cache coherency control illustrated in FIG. 2, using a TLB controlled by software, only access right that corresponds to the exclusive constraint of the MESI protocol out of the access rights recorded in the page table is set in the TLB 107. Accordingly, the access right recorded in the TLB 107 is the same as the access right recorded in the page table 108 of the system memory 103 or one to which the constraint is added.

For a TLB miss interrupt or storage interrupt, a local processor 101 searches for a TLB entry, that is, registration information for a remote processor 101 that needs to be updated so as to conform to the exclusive constraint of the MESI protocol by referring to the TLB directory memory 121. To prevent a plurality of processors 101 from simultaneously updating the TLB directory memory 121, sequential access using a semaphore may be preferably employed in accessing the TLB directory memory 121. The TLB directory memory 121 may preferably be implemented by content addressable memory (CAM). For a CAM, a search word contains a physical page number and a read/write/execute access permission bit, and one in which a processor ID and a TLB entry number are joined is an address input of the CAM. A bus used in CAM access may preferably be one independently of a memory bus and dedicated to a CPU. Examples of such a bus include a device control register (DCR) bus.

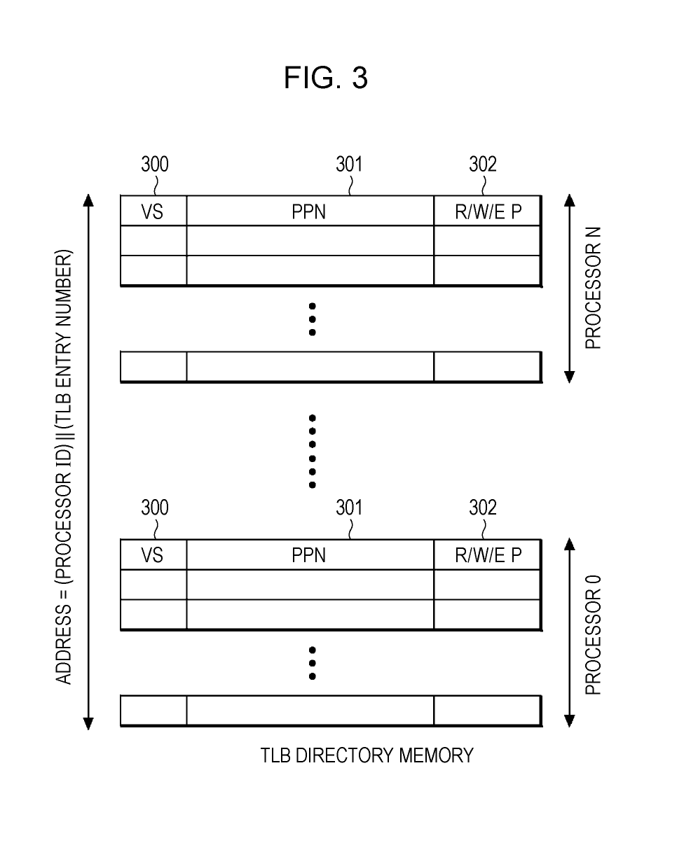

FIG. 3 schematically illustrates a configuration of the TLB directory memory 121. The TLB directory memory 121 retains entries, that is, registration information in the TLBs 107 of the processors 101 to allow each of the processors 101 to track an entry, that is, registration information for the TLBs 107 of the other processors 101 without an inter-processor interrupt. Cache is controlled such that only a page of an entry, that is, registration information registered in the TLB 107 of each of the processors 101 is allowed to be cached, thus enabling a use status of a page in each cache to be determined by searching the TLBs 107. The TLB directory memory 121 is mapped to a global address space so as to allow all the processors 101 to access it. Each entry in the TLB directory memory 121 includes valid status information 300 indicated by VS (valid status), physical page number information 301 indicated by PPN (physical page number), and read/write/execute access right protection information 302 indicated by R/W/E P (read/write/execute protection). These are ones duplicated from corresponding information held in the TLBs 107 of all the processors 101. At the left end, the address of the TLB directory memory 121 formed from the combination of a processer ID and a TLB entry number is indicated; at the right end, groups of entries corresponding to processor 0 to processer N are indicated. The physical page numbers in the TLBs 107 of the processors 101 are searched using the TLB directory memory 121, thus enabling coherency among different processes to be dealt with. Preferably, the TLB directory memory 121 may be faster by being implemented by CAM to achieve the next two searching operations: one is a search for a page that matches a physical page number and with write permission and the other is a search for a page that matches a physical page number and with read, write, or execute permission. In a search, a search word input of CAM contains a physical page number and permission to access a page, and one in which a processor ID and a TLB entry number are joined is input in an address input of CAM. A bus occupied by a processor, such as the DCR bus, is suited for a bus for use in accessing CAM.

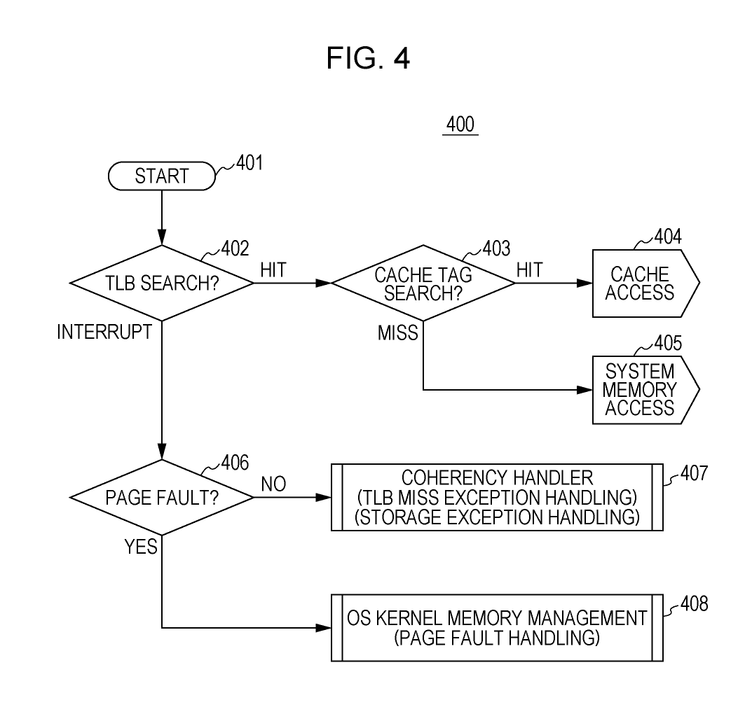

FIG. 4 is a flowchart (400) that schematically illustrates a method for controlling cache coherency according to one embodiment of the present invention. This method can be achieved by the processor 101 whose TLB is controlled by software, as illustrated in FIG. 2. The process starts when an application program accesses the cache (step 401), and the processor 101 performs a TLB search (step 402). When a hit occurs in the TLB search, the processor 101 searches for the cache tag of the hitting TLB entry (step 403). When a hit occurs in the cache tag search, the processor 101 instructs making access to the cache and makes the access to the cache (step 404). When no hit occurs but a cache tag miss occurs in the cache tag search, the processor 101 instructs making access to the system memory and makes the access to the system memory (step 405). When no hit occurs but a TLB interrupt occurs in the TLB search (step 402), the processor 101 determines whether the TLB interrupt is a page fault (step 406). When determining that the TLB interrupt is not a page fault, that is, a page of the TLB entry, that is, of registration information is present in the page table (NO in step 406), the processor 101 executes a subroutine of TLB miss exception handling or storage exception handling using the coherency handler (step 407). When determining that the TLB interrupt is a page fault (YES in step 406), the processor 101 generates a page fault interrupt and executes a subroutine of page fault handling using the memory managing unit of the OS kernel processing (step 408).

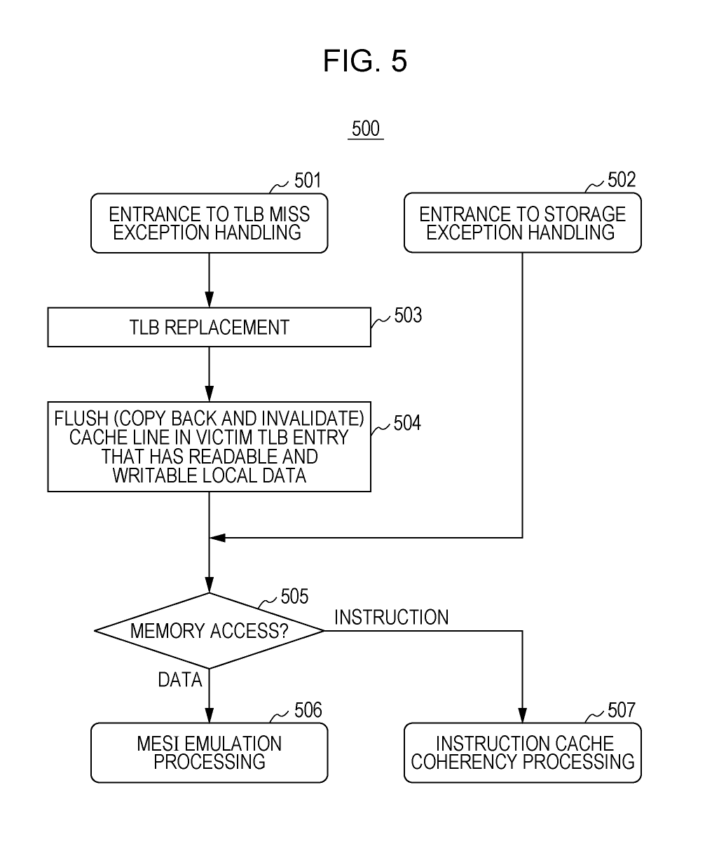

FIG. 5 is a flowchart (500) that illustrates eviction processing on a victim TLB entry, that is, registration information in a subroutine of TLB miss exception handling and storage exception handling by the coherency handler (see step 407 in FIG. 4). The subroutine of TLB miss exception handling by the coherency handler starts at the entrance to the TLB miss exception handling (step 501), and that of storage exception handling by the coherency handler starts at the entrance to the storage exception handling (step 502). For the TLB miss exception handling, because no entry, that is, registration information that matches the address exists in the TLB 107, the processor 101 executes TLB replacement of importing a matching entry, that is, registration information from the page table 108 to the TLB 107 (step 503). At this time, the TLB directory memory 121 updates the entry, that is, registration information. When executing the TLB replacement, the processor 101 flushes (copies back and invalidates) a local data cache line belonging to a physical page covered by a victim TLB entry, that is, registration information to be evicted and discarded (step 504). This enables only the entry, that is, registration information registered in the TLB to be reliably cached in a local processor, and thus, the necessity for coherency control can be determined simply by examining the TLB of a remote processor in the case of a TLB miss interrupt or storage interrupt. After step 504, the processor 101 determines whether the memory access causing the TLB miss interrupt or storage interrupt is data access or instruction access (step 505). The processor 101 proceeds to the subroutine 506 of MESI emulation processing when determining that it is data access (“DATA” in step 505) and proceeds to the subroutine 507 of instruction cache coherency processing when determining that it is instruction access (“INSTRUCTION” in step 505).

As briefly mentioned above, for both a TLB miss interrupt and a storage interrupt, in replacing or updating a TLB entry, that is, registration information, the read/write/execute right conforming to the MESI protocol described below for the exclusive constraint, for example, invalidate-on-write is set between a local TLB and a remote TLB.

### Sharing Read-Only Data

A plurality of processors can share the right to read and execute to the same physical page. If a TLB interrupt occurs in a data read or instruction fetch and a remote processor has the right to write to that physical page, that remote processor is notified of a clean command by an IPI, and that remote processor is made to clear the right to write to that physical page.

### Exclusive Control of Writing Data

When a processor has right to write to a physical page, the other processors do not have any kind of access right to that page. In other words, a remote TLB does not have any kind of access right to a physical page to which a local TLB has right to write. Accordingly, when access for writing causes a TLB miss interrupt or storage interrupt, a remote TLB is checked to determine whether a remote processor has access right to the physical page; if it has such access right, the remote processor is made using an IPI to flush the data of that physical page from the remote cache.

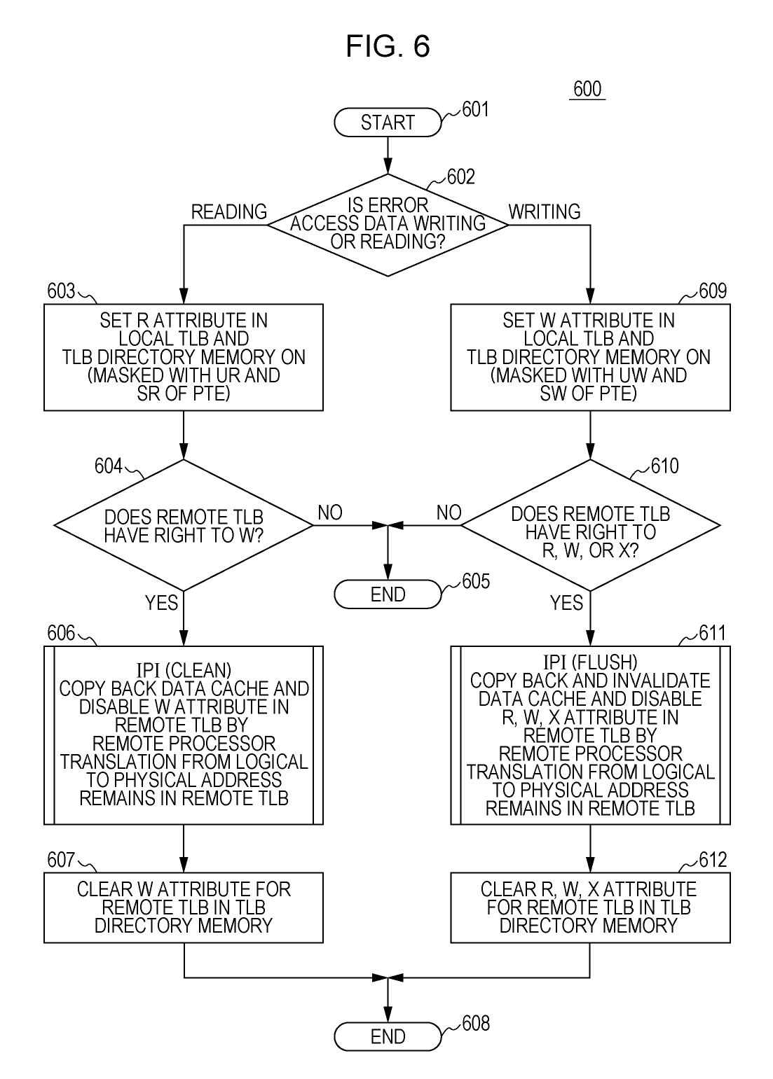

FIG. 6 is a flowchart (600) for MESI emulation processing as one example in which a MESI protocol constraint is imposed by software control. When determining (in step 505) in FIG. 5 that the memory access is data access, the processor 101 proceeds to the subroutine 506 of MESI emulation processing and starts that processing (step 601). First, the processor 101 determines whether error access causing the TLB interrupt is a data write or read (step 602). When determining that it is a data read, the processor 101 masks the read (R) attribute of the entry, that is, registration information corresponding to the physical page of the error access in the local TLB 107 and the TLB directory memory 121 by user read only (UR) and supervisor read only (SR) bits of the page table entry (PTE) in the page table 108 and sets it on (step 603). Then, the processor 101 searches the TLB directory memory 121 for the physical page of the error access and determines whether a remote TLB has right to write (W) to that physical page (step 604). When it is determined that it has no right to W (NO in step 604), the processing ends (step 605). When it is determined that it has right to W (YES in step 604), the processor 101 notifies the remote processor of a clean command by an IPI and causes the remote processor to clear the right to write to that physical page. That is, the remote processor copies back the data cache and disables the write (W) attribute of the entry, that is, registration information corresponding to that physical page in the remote TLB (step 606). The translation from logical to physical address remains in that entry in the remote TLB. Subsequently, the processor 101 clears the W attribute of the entry, that is, registration information corresponding to that physical page for the remote TLB in the TLB directory memory 121 (step 607), and the processing ends (step 608).

When determining (in step 602) that the error access is writing, the processor 101 masks the W attribute of the entry, that is, registration information corresponding to the physical page of the error access in the local TLB 107 and the TLB directory memory 121 by user write (UW) and supervisor write (SW) bits of the page table entry (PTE) in the page table 108 and sets it on (step 609). Then, the processor 101 searches the TLB directory memory 121 for the physical page of the error access and determines whether a remote TLB has right to read (R), write (W), or execute (X) to that physical page (step 610). When it is determined that it has no right to R, W, or X (NO in step 610), the processing ends (step 605). When it is determined that it has right to R, W, or X (YES in step 610), the processor 101 notifies the remote processor of a flush command by an IPI and causes the remote processor to flush the data of that physical page from the remote cache without providing the remote processor with the access right to that physical page. That is, the remote processor copies back and invalidates the data cache and disables the R, W, and X attributes of the entry, that is, registration information corresponding to that physical page in the remote TLB (step 611). The translation from logical to physical address remains in that entry in the remote TLB. Subsequently, the processor 101 clears the R, W, and X attributes of the entry, that is, registration information corresponding to that physical page for the remote TLB in the TLB directory memory 121 (step 612), and the processing ends (step 608).

In such a way, snoop filtering, that is, snoop deletion using TLB by setting the read, write, execute right in accordance with the MESI protocol constraint is performed. A determination step of limiting the occurrence of a broadcast of a snoop request that is an issue in implementing the MESI protocol by hardware to the case where the physical page covering that data is also registered in a remote TLB is added. Accordingly, the MESI emulation processing in which the MESI protocol constraint is imposed by software control can have higher scalability, in comparison with the implementation of the MESI protocol by hardware.

With the coherency handler for cache coherency control according to one embodiment of the present invention, both coherency between data caches and coherency between an instruction cache and a data cache can be controlled. This is achieved by invalidating the instruction cache line when a TLB miss interrupt results from an instruction fetch to a writable page with writing permission right. Like Linux, to support a dynamic link library, for example, it is necessary that an instruction cache be coherent to a data cache. For Linux, it is necessary to invalidate an instruction cache only when a writable page in a user space is fetched.

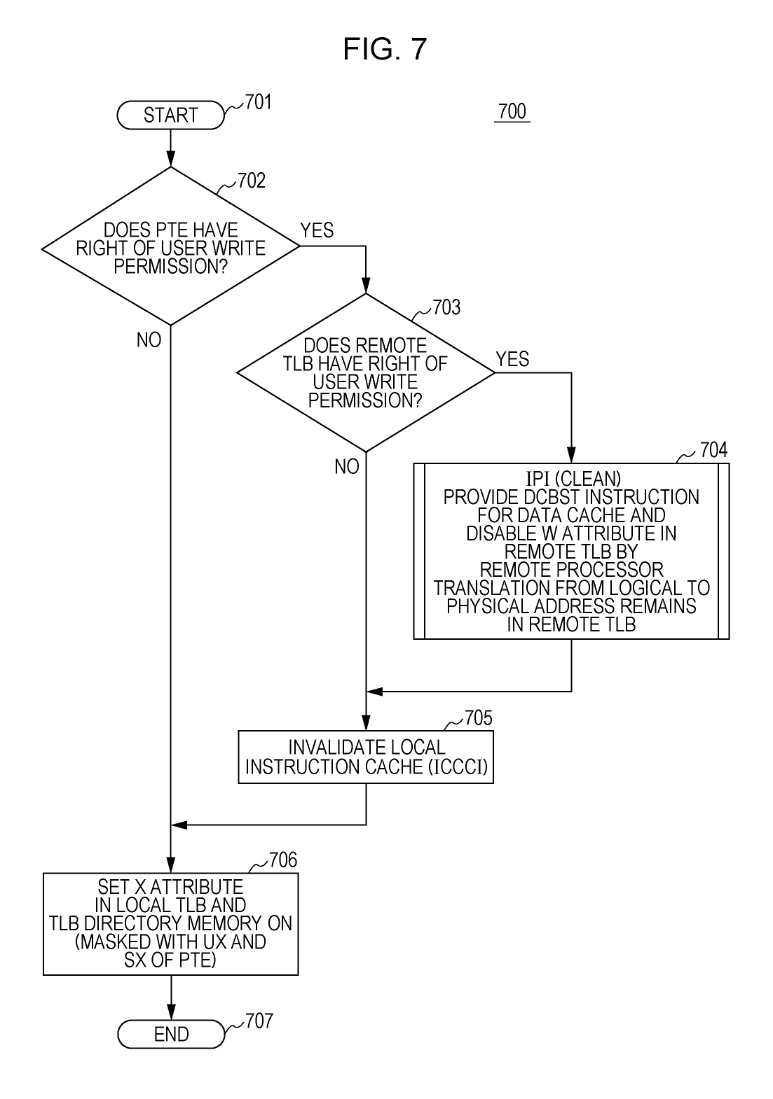

FIG. 7 is a flowchart (700) that illustrates instruction cache coherency processing by software control. When determining (in step 505) in FIG. 5 that the memory access is instruction access, the processor 101 proceeds to the subroutine 507 of instruction cache coherency processing and starts that processing (step 701). First, the processor 101 determines whether the PTE of the page table 108 has right of user write permission to the physical page at which the TLB miss interrupt results from the instruction fetch (step 702). When determining that the PTE has the right of user write permission (YES in step 702), the processor 101 determines whether a remote TLB has the right of user write permission to the physical page (step 703). When determining that the remote TLB has the right of user write permission (YES in step 703), the processor 101 notifies the remote processor of a clean command by an IPI and causes the remote processor to clear the right of user write permission. That is, the remote processor provides a data cache block store (dcbst) instruction for the data cache, stores the data cache line, and disables the W attribute in the remote TLB (step 704). The translation from logical to physical address remains in that entry in the remote TLB. Then, as in the case where it is determined in step 703 that the TLB does not have the right of user write permission (NO in step 703), the processor 101 invalidates the local instruction cache by the instruction cache congruence class invalidate (iccci) (step 705). Subsequently, as in the case where it is determined in step 702 that the PTE does not have the right of user write permission (NO in step 702), the processor 101 masks the execute (X) attribute of the entry, that is, registration information corresponding to the physical page at which the TLB miss interrupt results from the instruction fetch in the local TLB 107 and the TLB directory memory 121 by user execute (UX) and supervisor execute (SX) bits of the page table entry (PTE) and sets it on (step 706). Then, the processing ends (step 707).

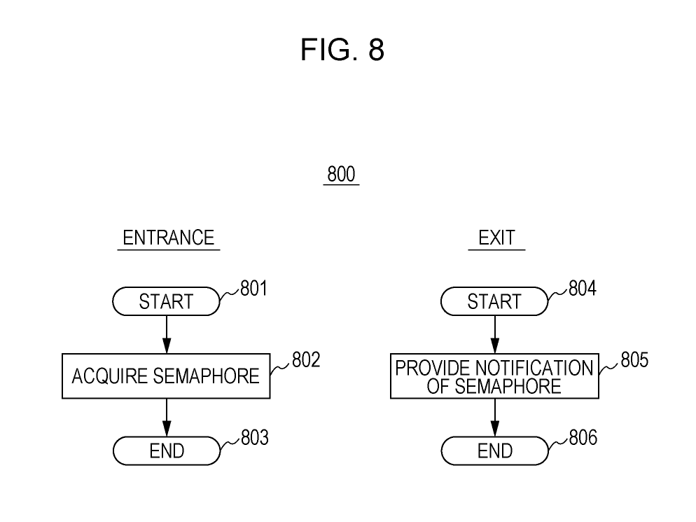

The TLB directory memory 121 is sequentially accessed using semaphores. This protects the TLB directory memory 121 from being simultaneously updated by the plurality of processors 101. FIG. 8 depicts flows (800) illustrating how a semaphore is used for an entrance and an exit of the coherency handler. For the entrance of the coherency handler, the processing starts (step 801), a semaphore is acquired (step 802), and the processing ends (step 803). For the exit of the coherency handler, the processing starts (step 804), notification of the semaphore is provided (step 805), and the processing ends (step 806). Although the entire TLB directory memory 121 can be exclusively accessed by a single semaphore, in order to enhance scalability of each of the plurality of processors and allow them to simultaneously access the TLB directory memory 121, it is preferable that a semaphore be divided to form semaphores and the semaphores be assigned to the respective groups into which a physical page is divided. For example, the residue system when the physical page number is divided by S is a semaphore ID, S semaphores are formed, and the divided physical page is protected for each group independently. Here, the following relationship is satisfied:

Semaphore ID=mod(physical page number, S)

where mod(a, b) represents the remainder when a is divided by b.

If this idea is applied to NUMA, which is a distributed shared memory system, different semaphores can be assigned for respective NUMA nodes. Only when remote access is made, remote TLB directory memory can be referred to and a semaphore can be acquired; otherwise local TLB directory memory can be referred to and a semaphore can be acquired.

For a NUMA system, assignment of a job to a processor and physical memory is optimized such that the frequency of access to local system memory is higher than that to remote system memory. For application to such a NUMA system, preferably, both TLB directory memory and semaphores are distributed to NUMA nodes. The distributed TLB directory memory records a physical page number of local system memory and the ID of a processor that caches it, and the distributed semaphores protect the corresponding distributed TLB directory memory. As a result, the remote TLB directory memory and the remote semaphore are referred to only when remote access occurs. Other local access can be processed using only the local TLB directory memory and the local semaphore.

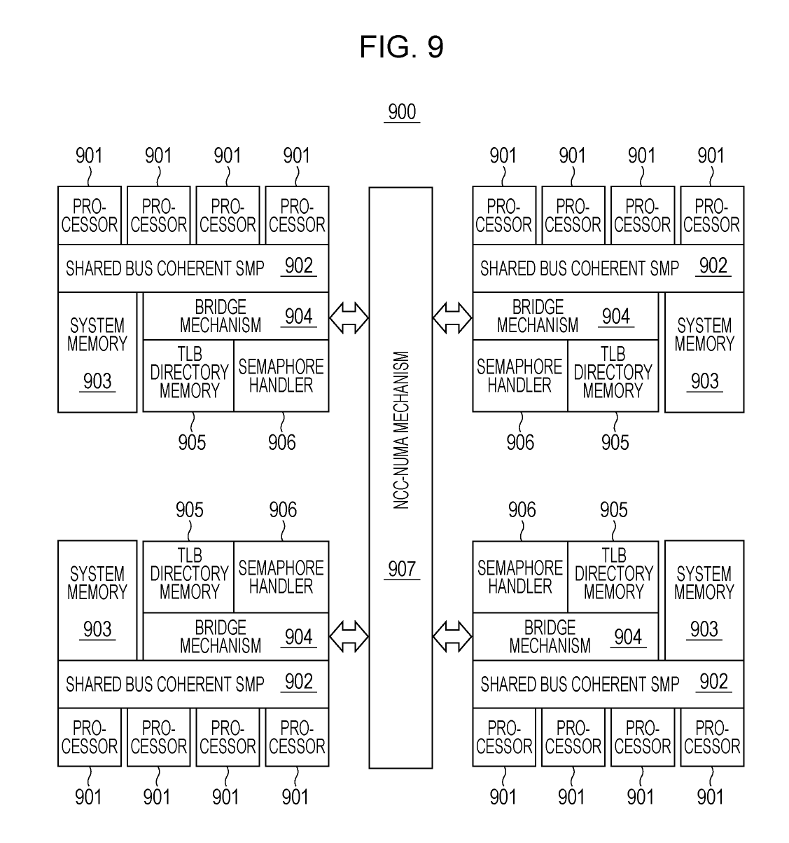

The cost of coherency supported by hardware is low for access to local system memory, but that is high for access to remote system memory. To address this, an extended hybrid system of SMP and NCC-NUMA in which inexpensive snoop bus is used for access to local system memory and cache coherency control according to the present invention is used for access to remote system memory is applicable. In other words, a shared memory multiprocessor system that is coherent as a whole in which coherency is supported by hardware for access to local system memory and the cache coherency control according to the present invention is used for access to remote system memory can be configured. FIG. 9 illustrates a coherent shared memory multiprocessor system 900 as an example extended to a hybrid system of SMP and NCC-NUMA. Each node includes a plurality of processors 901, a system memory 903 connected to the processors 901 by a coherent shared bus, that is, shared bus coherent SMP 902, and TLB directory memory 905 and a semaphore handler 906, both of which are connected to the shared bus coherent SMP 902 by a bridge mechanism 904. The semaphore handler 906 is provided to allow the plurality of processors 901 to sequentially access to the TLB directory memory 905 by a semaphore. The nodes are connected to each other by an NCC-NUMA mechanism 907. Because the nodes are connected to each other by the inexpensive NCC-NUMA mechanism 907, the shared memory multiprocessor system 900 can increase the number of nodes, that is, can improve the scalability while the cost of hardware is kept low.

If the number of entries in the TLB directory memory is not limited and both local system memory and remote system memory can be associated freely, the size of the TLB directory memory increases in proportion to the number of processors. For example, if each of 1024 processors has TLB of 1024 entries and 1 entry is 4 bytes, the size of the TLB directory memory is 4 MB by the following calculation:

(1024 processors)*(1024 entries)*(4 bytes)=4 MB

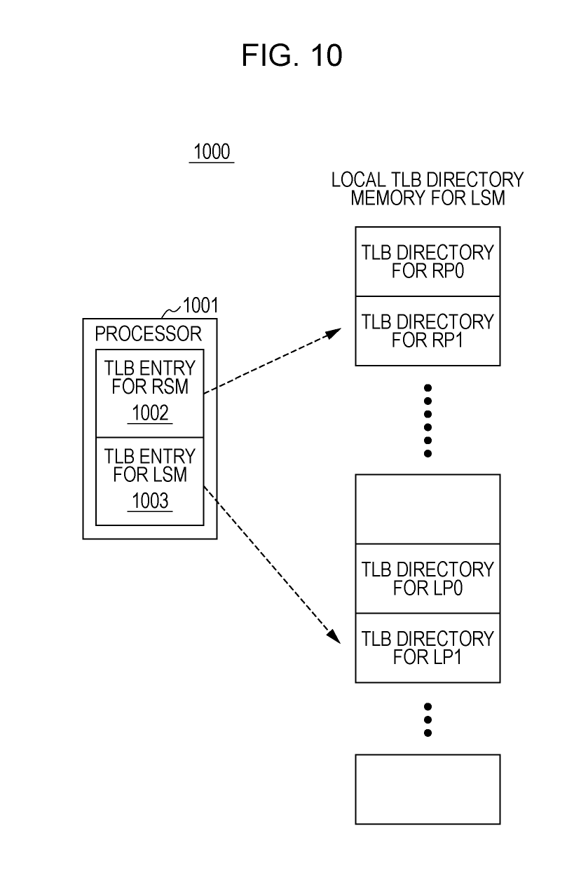

To reduce the size of the TLB directory memory, if the system is applied to a NUMA system, for example, as illustrated in FIG. 10, the number of TLB entries 1002 for RSM assigned to the remote system memory (RSM) by each processor 1001 is restricted, and the remaining is used as TLB entries 1003 for LSM assigned to local system memory (LSM). A local TLB directory memory 1000 for LSM includes entries duplicated from TLB directories for remote processor (RP), the number of TLB entries being restricted, and entries duplicated from TLB directories for local processor (LP) to which the remaining TLB entries are assigned, and the size thereof can be reduced. In particular, where the number of NUMA nodes is N, the number of TLB entries per CPU is E, and the number of entries assigned to remote system memory out of the TLB entries is R, the number of TLB entries assigned to local system memory is E-R, and therefore, the number of entries of the TLB directory memory per node is reduced from E*N to (N−1)*R+1*(E−R). For the above example, when 1024 processors are distributed to 256 NUMA nodes and a 4-way SMP structure is used in each node, if the number of TLB entries assigned to remote TLB is restricted to 16, the size of the TLB directory memory is 81.4 KB by the following calculation:

(1020 processors)*(16 entries)*(4 bytes)+(4 processors)*(1008 entries)*(4 bytes)=81.4 KB

When it is implemented on a CAM, in the case of 45 nm semiconductor technology, the area of a region required for the TLB directory memory is only 1 mm².

As described above, when the cache coherency control by software according to the present invention is performed, because a shared memory multiprocessor system can be formed from an inexpensive component, such as a general-purpose component, the hardware cost can be suppressed to the degree equivalent to a cluster, and the scalability can be improved. Searching a small-scale TLB directory memory that manages only TLB information for each processor for a physical page both enables dealing with a plurality of processes and eliminates the need to change an application program, thus improving the scalability without incurring additional software cost.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims

1. A method for controlling cache coherency of a multiprocessor system in which a plurality of processors share a system memory, each of the plurality of processors including a cache and a TLB, the method comprising:
when a processor of the plurality of processors determines that a TLB interrupt that is not a page fault occurs in a TLB search,
performing, by the processor, a TLB miss exception handling step of handling the TLB interrupt being a TLB miss interrupt occurring when no registration information having a matching address exists in the TLB or a storage exception handling step of handling the TLB interrupt being a storage interrupt occurring when registration information having a matching address exists in the TLB but access right is invalid.

2. The method according to claim 1, wherein the TLB miss exception handling step includes the step of flushing a data cache line of a cache belonging to a physical page covered by a victim TLB entry evicted and discarded when TLB replacement is executed.

3. The method according to claim 2, wherein the TLB miss exception handling step or the storage exception handling step includes the steps of:
determining whether memory access that caused the TLB miss interrupt or the storage interrupt is data access or instruction access; and
when determining that the memory access is the data access, providing right to write, read, and execute to a physical page covered by a TLB entry replaced or updated in association with the access with exclusive constraint that it is exclusive of access right to the physical page in the TLB of another processor.

4. The method according to claim 3, wherein the step of providing the right to write, read, and execute with the exclusive constraint includes a processing step of providing the right to write, read, and execute with invalidate-on-write constraint.

5. The method according to claim 4, wherein the step of providing the right to write, read, and execute with the invalidate-on-write constraint includes an MESI emulation processing step of providing the right to write, read, and execute with constraint of the MESI protocol.

6. The method according to claim 5, wherein the MESI emulation processing step includes the steps of:
determining whether the memory access is a data write or read;
when determining that the memory access is the data read, setting on a read attribute to the physical page of the access in the TLB of the processor and the TLB directory memory retaining registration information for the TLBs of the plurality of processors;
searching the TLB directory memory for the physical page of the access and determining whether the TLB of the other processor has right to write to the physical page of the access;
when determining that the other processor has the right to write, notifying the other processor of a clean command by an inter-processor interrupt and causing the other processor to clear the right to write to the physical page of the access; and
clearing a write attribute to the physical page of the access for the TLB of the other processor in the TLB directory memory.

7. The method according to claim 6, wherein the step of causing the other processor to clear the right to write to the physical page of the access includes the step of causing the other processor to copy back the data cache and to disable the write attribute to the physical page of the access in the TLB of the other processor.

8. The method according to claim 7, wherein the MESI emulation processing includes the steps of:
when determining that the memory access is the data write, setting on the write attribute to the physical page of the access in the TLB of the processor and the TLB directory memory;
searching the TLB directory memory to the physical page of the access and determining whether the TLB of the other processor has the right to read, write, or execute to the physical page of the access;
when determining that the other processor has the right to write, read, or execute to the physical page, notifying the other processor of a flush command by an inter-processor interrupt and causing the other processor to clear the right to read, write and execute to the physical page of the access; and
clearing the read, write, and execute attributes to the physical page of the access for the TLB of the other processor in the TLB directory memory.

9. The method according to claim 8, wherein the step of causing the other processor to clear the right to read, write, and execute to the physical page of the access includes the step of causing the other processor to copy back and invalidate the data cache and to disable the read, write, and execute attributes to the physical page of the access in the TLB of the other processor.

10. The method according to claim 2, wherein the TLB miss exception handling step or the storage exception handling step includes the steps of:
determining whether memory access that caused the TLB miss interrupt or the storage interrupt is data access or instruction access;
when determining that the memory access is the instruction access, determining whether an entry in a page table in the system memory has right of user write permission to the physical page at which the TLB miss interrupt results from an instruction fetch;
when determining that the entry in the page table has the right of user write permission, determining whether the TLB of the other processor has right of user write permission to the physical page; and
when determining that the TLB of the other processor has the right of user write permission, notifying the other processor of a clean command by an inter-processor interrupt and causing the other processor to clear the right of user write permission.

11. The method according to claim 10, wherein, when it is determined that the TLB of the other processor does not have the right of user write permission or after the step of causing the other processor to clear the right of user write permission, the TLB miss exception handling step or the storage exception handling step includes the step of invalidating an instruction cache of the processor that made the access.

12. The method according to claim 11, wherein, when it is determined that the entry in the page table does not have the right of user write permission or after the step of invalidating the instruction cache of the processor that made the access, the TLB miss exception handling step or the storage exception handling step includes the step of setting on the execute attribute to the physical page at which the TLB miss interrupt results from the instruction fetch in the TLB of the processor that made the access and the TLB directory memory retaining registration information for the TLBs of the plurality of processors.

13. The method according to claim 8, wherein the MESI emulation processing step further includes the step of making sequential access using a semaphore in searching the TLB directory memory for the physical page of the access.

14. A system for controlling cache coherency of a multiprocessor system in which a plurality of processors each including a cache and a TLB share a system memory,
wherein each of the processor further includes a TLB controller including a TLB search unit that performs a TLB search and a coherency handler that performs TLB registration information processing when no hit occurs in the TLB search and a TLB interrupt occurs,
the coherency handler includes a TLB replacement handler, a TLB miss exception handling unit, and a storage exception handling unit,
the TLB replacement handler searches a page table in the system memory and performs replacement on TLB registration information,
when the TLB interrupt is not a page fault, the TLB miss exception handling unit handles the TLB interrupt being a TLB miss interrupt occurring when no registration information having a matching address exists in the TLB and the storage exception handling unit handles the TLB interrupt being a storage interrupt occurring when registration information having a matching address exists in the TLB but access right is invalid.

15. The system according to claim 14, wherein the TLB miss exception handling unit flushes a data cache line of a cache belonging to a physical page covered by a victim TLB entry evicted and discarded when TLB replacement is executed.

16. The system according to claim 15, wherein each of the TLB miss exception handling unit and the storage exception handling unit determines whether memory access that caused the TLB miss interrupt or the storage interrupt is data access or instruction access, and
when determining that the memory access is the data access, provides right to write, read, and execute to a physical page covered by a TLB entry replaced or updated in association with the access with exclusive constraint that it is exclusive of access right to the physical page in the TLB of another processor.

17. The system according to claim 15, wherein each of the TLB miss exception handling unit and the storage exception handling unit determines whether memory access that caused the TLB miss interrupt or the storage interrupt is data access or instruction access,
when determining that the memory access is the instruction access, determines whether an entry in a page table in the system memory has right of user write permission to the physical page at which the TLB miss interrupt results from an instruction fetch,
when determining that the entry in the page table has the right of user write permission, determines whether the TLB of the other processor has right of user write permission to the physical page, and
when determining that the TLB of the other processor has the right of user write permission, notifies the other processor of a clean command by an inter-processor interrupt and causes the other processor to clear the right of user write permission.

18. The system according to claim 17, further comprising a TLB directory memory that retains registration information for the TLBs of the plurality of processors and that is searched for a physical page by the plurality of processors.

19. The system according to claim 18, wherein the multiprocessor system includes a plurality of nodes,
each of the plurality of nodes includes the plurality of processors, the system memory connected to the plurality of processors by a coherent shared bus, and the TLB directory memory, and a semaphore handler that is used in sequential access to the TLB directory memory by the plurality of processors using a semaphore, the TLB directory memory and the semaphore handler being connected to the coherent shared bus by a bridge mechanism, and
the plurality of nodes are connected to each other by an NCC-NUMA mechanism.
